(19) United States
(12) Patent Application Publication
(10) Pub. No.: US 2007/0265167 A1
(43) Pub. Date: Nov. 15, 2007

(54) Treating horticultural crops

(76) Inventors: Todd Edgington, Lansdale, PA (US); Deirdre Holcroft, Davis, CA (US); Lynn Oakes, Doylestown, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/801,773

(22) Filed: May 11, 2007

Related U.S. Application Data
(60) Provisional application No. 60/800,516, filed on May 15, 2006.

(51) Int. Cl. A01N 27/00

(52) U.S. Cl. 504/357

(57) ABSTRACT

There is provided a method of treating horticultural crop plants comprising the step of contacting said plants one or more times with a liquid composition, wherein said liquid composition comprises one or more cyclopropenes, and wherein said contacting is performed during a reproductive stage of said plants.

This application claims the benefit of priority under 35 U.S.C. §119(e) of U.S. Provisional Patent Application No. 60/800,516 filed on May 15, 2006.

### BACKGROUND

Crop plants are often treated by contacting them with compositions. One possible benefit of such treatment is the improvement of crop yield. For example, US Patent Publication 2006/0160704 discloses treating non-citrus plants with compositions that contain at least one cyclopropene and that contain at least one plant growth regulator that is not a cyclopropene. It is desired to provide methods that involve treating certain specific crop plants with liquid compositions at developmental stage or stages appropriate for those specific crop plants.

### STATEMENT OF THE INVENTION

In one aspect of the present invention, there is provided a method of treating horticultural crop plants comprising the step of contacting said plants one or more times with a liquid composition, wherein said liquid composition comprises one or more cyclopropenes, and wherein said contacting is performed during a reproductive stage of said plants.

### DETAILED DESCRIPTION

The practice of the present invention involves the use of one or more cyclopropenes. As used herein, “a cyclopropene” is any compound with the formula

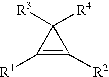

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. The R¹, R², R³, and R⁴ groups may be the same as each other, or any number of them may be different from the others. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted. Independently, groups that are suitable for use as one or more of R¹, R², R³, and R⁴ may be connected directly to the cyclopropene ring or may be connected to the cyclopropene ring through an intervening group such as, for example, a heteroatom-containing group.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent. It is contemplated that such substituted groups may be made by any method, including but not limited to making the unsubstituted form of the chemical group of interest and then performing a substitution. Suitable substituents include, for example, alkyl, alkenyl, acetylamino, alkoxy, alkoxyalkoxy, alkoxycarbonyl, alkoxyimio, carboxy, halo, haloalkoxy, hydroxy, alkylsulfonyl, alkylthio, trialkylsilyl, dialkylamino, and combinations thereof. An additional suitable substituent, which, if present, may be present alone or in combination with another suitable substituent, is

-(L)ₘ-Z

where m is 0 to 8, and where L and Z are defined herein above. If more than one substituent is present on a single chemical group of interest, each substituent may replace a different hydrogen atom, or one substituent may be attached to another substituent, which in turn is attached to the chemical group of interest, or a combination thereof.

Among the suitable R¹, R², R³, and R⁴ groups are, for example, substituted and unsubstituted aliphatic-oxy groups, such as, for example, alkenoxy, alkoxy, alkynoxy, and alkoxycarbonyloxy.

Also among the suitable R¹, R², R³, and R⁴ groups are, for example, substituted and unsubstituted alkylphosphonato, substituted and unsubstituted alkylphosphato, substituted and unsubstituted alkylamino, substituted and unsubstituted alkylsulfonyl, substituted and unsubstituted alkylcarbonyl, and substituted and unsubstituted alkylaminosulfonyl, including, for example, alkylphosphonato, dialkylphosphato, dialkylthiophosphato, dialkylamino, alkylcarbonyl, and dialkylaminosulfonyl.

Also among the suitable R¹, R², R³, and R⁴ groups are, for example, substituted and unsubstituted cycloalkylsulfonyl groups and cycloalkylamino groups, such as, for example, dicycloalkylaminosulfonyl and dicycloalkylamino.

Also among the suitable R¹, R², R³, and R⁴ groups are, for example, substituted and unsubstituted heterocyclyl groups (i.e., aromatic or non-aromatic cyclic groups with at least one heteroatom in the ring).

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted aryl groups. Suitable substituents are those described herein above. In some embodiments, one or more substituted aryl group is used in which at least one substituent is one or more of alkenyl, alkyl, alkynyl, acetylamino, alkoxyalkoxy, alkoxy, alkoxycarbonyl, carbonyl, alkylcarbonyloxy, carboxy, arylamino, haloalkoxy, halo, hydroxy, trialkylsilyl, dialkylamino, alkylsulfonyl, sulfonylalkyl, alkylthio, thioalkyl, arylaminosulfonyl, and haloalkylthio.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy,: carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring sysytems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In some embodiments, G is a ring system that contains a saturated or unsaturated 3 membered ring, such as, for example, a substituted or unsubstituted cyclopropane, cyclopropene, epoxide, or aziridine ring.

In some embodiments, G is a ring system that contains a 4 membered heterocyclic ring; in some of such embodiments, the heterocyclic ring contains exactly one heteroatom. Independently, in some embodiments, G is a ring system that contains a heterocyclic ring with 5 or more members; in some of such embodiments, the heterocyclic ring contains 1 to 4 heteroatoms. Independently, in some embodiments, the ring in G is unsubstituted; in other embodiments, the ring system contains 1 to 5 substituents; in some of the embodiments in which G contains substituents, each substituent is independently chosen from the substituents described herein above. Also suitable are embodiments in which G is a carbocyclic ring system.

In some embodiments, each G is independently a substituted or unsubstituted phenyl, pyridyl, cyclohexyl, cyclopentyl, cycloheptyl, pyrolyl, furyl, thiophenyl, triazolyl, pyrazolyl, 1,3-dioxolanyl, or morpholinyl. Among these embodiments include those embodiments, for example, in which G is unsubstituted or substituted phenyl, cyclopentyl, cycloheptyl, or cyclohexyl. In some of these embodiments, G is cyclopentyl, cycloheptyl, cyclohexyl, phenyl, or substituted phenyl. Among embodiments in ,which G is substituted phenyl are embodiments, for example, in which there are 1, 2, or 3 substituents. Independently, also among embodiments in which G is substituted phenyl are embodiments, for example, in which the substituents are independently selected from methyl, methoxy, and halo.

Also contemplated are embodiments in which R³ and R⁴ are combined into a single group, which is attached to the number 3 carbon atom of the cyclopropene ring by a double bond. Some of such compounds are described in US Patent Publication 2005/0288189.

In some embodiments, one or more cyclopropenes are used in which one or more of R¹, R², R³, and R⁴ is hydrogen. In some embodiments, R¹ or R² or both R¹ and R² is hydrogen. Independently, in some embodiments, R³ or R⁴ or both R³ and R⁴ is hydrogen. In some embodiments, R², R³, and R⁴ are hydrogen.

In some embodiments, one or more of R¹, R², R³, and R⁴ is a structure that has no double bond. Independently, in some embodiments, one or more of R¹, R², R³, and R⁴ is a structure that has no triple bond. Independently, in some embodiments, one or more of R¹, R², R³, and R⁴is a structure that has no halogen atom substituent. Independently, in some embodiments, one or more of R¹, R², R³, and R⁴ is a structure that has no substituent that is ionic.

In some embodiments, one or more of R¹, R², R³, and R⁴ is hydrogen or (C₁-C₁₀) alkyl. In some embodiments, each of R¹, R², R³, and R⁴is hydrogen or (C₁-C₈) alkyl. In some embodiments, each of R¹, R², R³, and R⁴ is hydrogen or (C₁-C₄) alkyl. In some embodiments, each of R¹, R², R³, and R⁴ is hydrogen or methyl. In some embodiments, R¹ is (C₁-C₄) alkyl and each of R², R³, and R⁴ is hydrogen. In some embodiments, R¹ is methyl and each of R², R³, and R⁴ is hydrogen, and the cyclopropene is known herein as “1-MCP.”

In some embodiments, a cyclopropene is used that has boiling point at one atmosphere pressure of 50° C. or lower; or 25° C. or lower; or 15° C. or lower. Independently, in some embodiments, a cyclopropene is used that has boiling point at one atmosphere pressure of −100° C. or higher; −50° C. or higher; or −25° C. or higher; or 0° C. or higher.

The cyclopropenes applicable to this invention may be prepared by any method. Some suitable methods of preparation of cyclopropenes are the processes disclosed in U.S. Pat. Nos. 5,518,988 and 6,017,849.

In some embodiments, one or more composition of the present invention includes at least one ionic complexing reagent. An ionic complexing reagent interacts with a cyclopropene to form a complex that is stable in water. Some suitable ionic complexing reagents, for example, include lithium ion. In some embodiments, no ionic complexing reagent is used.

In some embodiments, no composition of the present invention includes any molecular encapsulating agent. In other embodiments, one or more composition of the present invention includes at least one molecular encapsulating agent.

When a molecular encapsulating agent is used, suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In some embodiments of the invention, the encapsulating agent is alpha-cyclodextrin, beta-cyclodextrin, gamma-cyclodextrin, or a mixture thereof. In some embodiments of the invention, particularly when the cyclopropene is 1-methylcyclopropene, the encapsulating agent is alpha-cyclodextrin. The preferred encapsulating agent will vary depending upon the structure of the cyclopropene or cyclopropenes being used. Any cyclodextrin or mixture of cyclodextrins, cyclodextrin polymers, modified cyclodextrins, or mixtures thereof can also be utilized pursuant to the present invention. Some cyclodextrins are available, for example, from Wacker Biochem Inc., Adrian, Mich. or Cerestar USA, Hammond, Ind., as well as other vendors.

In some of the embodiments in which a molecular encapsulating agent is present, at least one molecular encapsulating agent encapsulates one or more cyclopropenes. A cyclopropene or substituted cyclopropene molecule encapsulated in a molecule of a molecular encapsulating agent is known herein as a “cyclopropene molecular encapsulating agent complex.” The cyclopropene molecular encapsulation agent complexes can be prepared by any means. In one method of preparation, for example, such complexes are prepared by contacting the cyclopropene with a solution or slurry of the molecular encapsulation agent and then isolating the complex, using, for example, processes disclosed in U.S. Pat. No. 6,017,849. For example, in one method of making a complex in which 1-MCP is encapsulated in a molecular encapsulating agent, the 1-MCP gas is bubbled through a solution of alpha-cyclodextrin in water, from which the complex first precipitates and is then isolated by filtration. In some embodiments, complexes are made by the above method and, after isolation, are dried and stored in solid form, for example as a powder, for later addition to useful compositions.

In some embodiments, one or more molecular encapsulating agent and one or more cyclopropenes are both present in a composition; in some of such embodiments, the amount of molecular encapsulating agent can usefully be characterized by the ratio of moles of molecular encapsulating agent to moles of cyclopropene. In some embodiments, the ratio of moles of molecular encapsulating agent to moles of cyclopropene is 0.1 or larger; or 0.2 or larger; or 0.5 or larger; or 0.9 or larger. Independently, in some of such embodiments, the ratio of moles of molecular encapsulating agent to moles of cyclopropene is 2 or lower; or 1.5 or lower.

In some embodiments, the composition of the present invention has no abscission agent.

The practice of the present invention involves one or more liquid compositions. Liquid compositions are liquid at 25° C. In some embodiments, liquid compositions are liquid at the temperature at which the composition is used to treat plants. Because plants are often treated outside of any buildings, plants may be treated at temperatures ranging from 1° C. to 45° C.; suitable liquid compositions need not be liquid over that entire range, but suitable liquid compositions are liquid at least at some temperature from 1° C. to 45° C.

If a liquid composition contains more than one substance, that liquid composition may be a solution or a dispersion or a combination thereof. If, in the liquid composition, one substance is dispersed in another substance in the form of a dispersion, the dispersion may be of any type, including, for example, a slurry, a suspension, a latex, an emulsion, a miniemulsion, a microemulsion, or any combination thereof.

The amount of cyclopropene in the composition may vary widely, depending on the type of composition and the intended method of use. In some embodiments, the amount of cyclopropene, based on the total weight of the composition, is 4% by weight or less; or 1% by weight or less; or 0.5% by weight or less; or 0.05% by weight or less. Independently, in some embodiments, the amount of cyclopropene, based on the total weight of the composition , is 0.000001% by weight or more; or 0.00001% by weight or more; or 0.0001% by weight or more; or 0.001% by weight or more.

Among embodiments of the present invention that use a composition of the present invention that contains water, the amount of cyclopropene may be characterized as parts per million (i.e., parts by weight of cyclopropene per 1,000,000 parts by weight of water in the composition, “ppm”) or as parts per billion (i.e., parts by weight of cyclopropene per 1,000,000,000 parts by weight of water in the composition, “ppb”). In some embodiments, the amount of cyclopropene is 1 ppb or more; or 10 ppb or more; or 100 ppb or more. Independently, in some embodiments, the amount of cyclopropene is 10,000 ppm or less; or 1,000 ppm or less.

In some embodiments, a liquid composition of the present invention is used in which some or all of the cyclopropene is encapsulated in one or more encapsulating agent

In some embodiments, no composition of the present invention includes metal-complexing agents. In some embodiments, one or more compositions of the present invention includes one or more metal-complexing agents.

One or more metal-complexing agents may be included in one or more liquid compositions. A metal-complexing agent is a compound that is capable of forming coordinate bonds with metal atoms. Some metal-complexing agents are chelating agents. As used herein, a “chelating agent” is a compound, each molecule of which is capable of forming two or more coordinate bonds with a single metal atom. Some metal-complexing agents form coordinate bonds with metal atoms because the metal-complexing agents contain electron-donor atoms that participate in coordinate bonds with metal atoms. Suitable chelating agents include, for example, organic and inorganic chelating agents. Among the suitable inorganic chelating agents are, for example, phosphates such as, for example, tetrasodium pyrophosphate, sodium tripolyphosphate, and hexametaphosphoric acid. Among the suitable organic chelating agents are those with macrocyclic structures and non-macrocyclic structures. Among the suitable macrocyclic organic chelating agents are, for example, porphine compounds, cyclic polyethers (also called crown ethers), and macrocyclic compounds with both nitrogen and oxygen atoms.

Some suitable organic chelating agents that have non-macrocyclic structures are, for example, aminocarboxylic acids, 1,3-diketones, hydroxycarboxylic acids, polyamines, aminoalcohols, aromatic heterocyclic bases, phenol, aminophenols, oximes, Shiff bases, sulfur compounds, and mixtures thereof. In some embodiments, the chelating agent includes one or more aminocarboxylic acids, one or more hydroxycarboxylic acids, one or more oximes, or a mixture thereof. Some suitable aminocarboxylic acids include, for example, ethylenediaminetetraacetic acid (EDTA), hydroxyethylethylenediaminetriacetic acid (HEDTA), nitrilotriacetic acid (NTA), N-dihydroxyethylglycine (2-HxG), ethylenebis(hydroxyphenylglycine) (EHPG), and mixtures thereof. Some suitable hydroxycarboxylic acids include, for example, tartaric acid, citric acid, gluconic acid, 5-sulfoslicylic acid, and mixtures thereof. Some suitable oximes include, for example, dimethylglyoxime, salicylaldoxime, and mixtures thereof. In some embodiments, EDTA is used.

Some additional suitable chelating agents are polymeric. Some suitable polymeric chelating agents include, for example, polyethyleneimines, polymethacryloylacetones, poly(acrylic acid), and poly(methacrylic acid). Poly(acrylic acid) is used in some embodiments.

Some suitable metal-complexing agents that are not chelating agents are, for example, alkaline carbonates, such as, for example, sodium carbonate.

Metal-complexing agents may be present in neutral form or in the form of one or more salts. Mixtures of suitable metal-complexing agents are also suitable.

In some embodiments of the present invention, no composition contains water. In some other embodiments, the composition of the present invention contains water.

Independently, in some embodiments in which a liquid composition that includes water is used, and in which the liquid composition contains one or more metal-complexing agent, the amount of metal-complexing agent can usefully be characterized by the molar concentration of metal-complexing agent in the liquid composition (i.e., moles of metal-complexing agent per liter of liquid composition). In some of such liquid compositions, the concentration of metal-complexing agent is 0.00001 mM (i.e., milli-Molar) or greater; or 0.0001 mM or greater; or 0.001 mM or greater; or 0.01 mM or greater; or 0.1 mM: or greater. Independently, in some embodiments in which a liquid composition of the present invention includes water, the concentration of metal-complexing agent is 100 mM or less; or 10 mM or less; or 1 mM or less.

In some embodiments of the present invention, one or more adjuvants is also included in the composition of the present invention. The use of adjuvants is considered optional in the practice of the present invention. Adjuvants may be used alone or in any combination. When more than one adjuvant is used, it is contemplated that any combination of one or more adjuvants may be used. Some suitable adjuvants are surfactants, alcohols, oils, extenders, pigments, fillers, binders, plasticizers, lubricants, wetting agents, spreading agents, dispersing agents, stickers, adhesives, defoamers, thickeners, transport agents, and emulsifying agents.

In some embodiments, a composition of the present invention is used that contains at least one adjuvant selected from alcohols, oils, and mixtures thereof; such a composition may or may not additionally contain one or more surfactant.

In some embodiments of the present invention, one or more surfactants are used. Suitable surfactants include, for example, anionic surfactants, cationic surfactants, nonionic surfactants, amphoteric surfactants, and mixtures thereof. In some embodiments, one or more anionic surfactant is used. Mixtures of suitable surfactants are also suitable.

Among embodiments in which one or more liquid compositions are used that include one or more surfactants, some liquid compositions contain surfactant in amounts, by weight based on the total weight of the liquid composition, of 0.025% or more; or 0.05% or more; or 0.1% or more. Independently, some liquid compositions use surfactant in amounts, by weight based on the total weight of the liquid composition, of 75% or less; or 50% or less; or 20% or less; or 5% or less; or 2% or less; 1% or less; or 0.5% or less; or 0.3% or less.

In some of the embodiments, no oil is included in the composition.

Independently, in some of the embodiments, one or more oils are used. As used herein, an “oil” is a compound that is liquid at 25° C. and 1 atmosphere pressure and that has a boiling point at 1 atmosphere pressure of 30° C. or higher. As used herein, “oil” does not include water, does not include surfactants (as described herein above), and does not include alcohols (as described herein below). Some oils are hydrocarbon oils, while other oils are non-hydrocarbon oils. Hydrocarbon oils are straight, branched, or cyclic alkane compounds with 6 or more carbon atoms. As used herein, “non-hydrocarbon” means any compound that contains at least one atom that is neither hydrogen nor carbon.

In some embodiments in which a liquid composition is used, one or more hydrocarbon oils are included in the composition. Some suitable hydrocarbon oils include, for example, hexane, decane, dodecane, hexadecane, diesel oil, refined paraffinic oil (e.g., Ultrafine™ spray oil from Sun Company), and mixtures thereof.

In some embodiments, one or more non-hydrocarbon oils are included in the composition. In some embodiments, non-hydrocarbon oils have boiling point of 50° C. or higher; or 75° C. or higher; or 100° C. or higher. Independently, in some embodiments, non-hydrocarbon oils have molecular weight of 100 or higher; or 200 or higher; or 500 or higher.

Some suitable non-hydrocarbon oils are, for example, fatty non-hydrocarbon oils. “Fatty” means herein any compound that contains one or more residues of fatty acids. Fatty acids are long-chain carboxylic acids, with chain length of at least 4 carbon atoms. Typical fatty acids have chain length of 4 to 18 carbon atoms, though some have longer chains. Some of the suitable fatty non-hydrocarbon oils, are, for example, esters of fatty acids. Such esters include, for example, glycerides of fatty acids, including triglycerides. One example of a suitable triglyceride of a fatty acid is soybean oil. Suitable fatty non-hydrocarbon oils may be synthetic or natural or modifications of natural oils or a combination or mixture thereof. Also among the suitable fatty non-hydrocarbon oils are self-emulsifying esters of fatty acids.

Another group of suitable non-hydrocarbon oils are silicone oils Silicone oils are oligomers or polymers that have a backbone that is partially or fully made up of —Si—O— links. Silicone oils include, for example, polydimethylsiloxane oils.

Mixtures of suitable oils are also suitable, including mixtures of plural hydrocarbon oils, mixtures of plural non-hydrocarbon oils, and mixtures of one or more hydrocarbon oil with one or more non-hydrocarbon oil.

Some embodiments use oil in amounts, by weight based on the total weight of the composition, of 0.25% or more; or 0.5% or more; or 1% or more. Independently, some embodiments use oil in amounts, by weight based on the total weight of the composition, of 90% or less; or 50% or less; or 10% or less; or 5% or less; or 4% or less; or 3% or less.

In some liquid compositions, one or more alcohols are used. Suitable alcohols include, for example, alkyl alcohols and other alcohols. As used herein, alkyl alcohols are alkyl compounds with one hydroxyl group; the alkyl group may be linear, branched, cyclic, or a combination thereof; the alcohol may be primary, secondary, or tertiary. In some embodiments, alkyl alcohols are used which have alkyl groups with 2 or more carbon atoms. In some embodiments, ethanol, isopropanol, or a mixture thereof is used. In some embodiments, one or more alkyl alcohols are used which have alkyl groups with 20 or fewer carbon atoms; or 10 or fewer carbon atoms; or 6 or fewer carbon atoms; or 3 or fewer carbon atoms.

Among liquid compositions that use alcohol, some liquid compositions use alcohol in amounts, by weight based on the total weight of the liquid composition, of 0.25% or higher; or 0.5% or higher, or 1% or higher. Among liquid compositions that use alcohol, some liquid compositions use alcohol in amounts, by weight based on the total weight of the liquid composition, of 90% or less; or 50% or less; or 10% or less; or 5% or less; or 4% or less; or 3% or less.

The ingredients of the present invention may be admixed by any means, in any order.

In the practice of the present invention, any method may be used that allows the liquid composition or compositions of the present invention to contact the plant. As used herein, contacting a plant with a liquid composition of the present invention is known herein as “treating” the plant. Some examples of methods of contact are, for example, spraying, foaming, fogging, pouring, brushing, dipping, similar methods, and combinations thereof. In some embodiments, spraying or dipping or both is used. In some embodiments, spraying is used.

Some plants are grown for the purpose of removing one or more plant parts, when such parts are considered a useful product. Such plants are known herein as “crop plants.” Removal of such useful plant parts is known as harvesting. In the practice of the present invention, plants that produce useful plant parts are treated with composition of the present invention prior to the harvesting of the useful plant parts. In such embodiments, each composition that is used may, independently of any other compositions that may be used, be brought into contact with all of or with some portion of the plant. If a composition is brought into contact with a portion of the plant, that portion may or may not include the useful plant part intended to be harvested.

A composition of the present invention is used to contact plants. It is contemplated that, in performing the treatment, the composition of the present invention may be contacted with the entire plant or may be contacted with one or more plant parts. Plant parts include any part of a plant, including, for example, flowers, buds, blooms, seeds, cuttings, roots, bulbs, fruits, vegetables, leaves, and combinations thereof.

In some embodiments, the liquid composition of the present invention is sprayed onto crop plants growing in a field. Such a spraying operation may be performed one time or more than one time on a particular group of crop plants during a single growing season. In some embodiments, the amount of cyclopropene used in one spraying operation is 0.1 gram per hectare (g/ha) or more; or 0.5 g/ha or more; or 1 g/ha or more. Independently, in some embodiments, the amount of cyclopropene used in one spraying operation is 500 g/ha or less; or 300 g/ha or less; or 100 g/ha or less; or 50 g/ha or less.

The growth and development process of many crop plants can be described by certain developmental stages. For example, many crop plants develop through vegetative stages followed by reproductive stages. Some crop plants develop through ripening stages after their reproductive stages. In the practice of the present invention, crop plants are contacted with a composition of the present invention one or more times during one or more reproductive stages. In some embodiments, crop plants may optionally be additionally contacted with a composition of the present invention one or more times prior to any reproductive stage, one or more times during any ripening stage, or a combination thereof.

Some crop plants develop through vegetative and reproductive processes simultaneously. It is contemplated to contact such crop plants with one or more composition of the present invention one or more times after germination but before harvest.

It is contemplated that, in some embodiments, contacting horticultural crop plants with a liquid composition of the present invention will result in improved crop yield. It is contemplated that, for some specific crop plants, there may be an optimum stage or stages at which to perform the contact with the composition of the present invention, in order to achieve the maximum improvement in crop yield. It is contemplated that such optimum stage or stages may be different for each type of crop plant, and such optimum stage or stages may, in some cases, depend on the specific growing conditions.

In some embodiments, it is contemplated to contact a group of crop plants at a certain desired stage of development. In such cases, it is contemplated that such contacting may be performed when the ratio of the number of plants that have reached the desired stage of development to the total number of plants in the group is at least 0.1, or at least 0.5, or at least 0.75, or at least 0.9 (i.e., when the portion of plants that have reached the desired stage of development is at least 10%, or 50%, or 75%, or 90%).

Suitable treatments may be performed on plants that are planted in a field, in a garden, in a building (such as, for example, a greenhouse), or in another location. Suitable treatments may be performed on a plants that are planted in open ground, in one or more containers (such as, for example, a pot, planter, or vase), in confined or raised beds, or in other places. In some embodiments in which treatment is performed in a building, it is contemplated that the building is not airtight. In some embodiments, treatment is performed outside of any building.

In the practice of the present invention, the plants that are treated are any plants that produce a horticultural crop. Horticultural crops are agricultural products that are not agronomic crops and are not forestry products. Agronomic crops are herbaceous field crops, including grains, forages, oilseeds, and fiber crops. Forestry products are forest trees and forest products. Horticultural crop plants are usually relatively intensively managed plants that are cultivated for food or for aesthetic purposes. Some typical horticultural crops are fruits, vegetables, spices, herbs, and plants grown for ornamental use.

In some embodiments, crop plants are treated that produce fruits, vegetables, spices, herbs, or plants or plant parts grown for ornamental use. In some embodiments, crop plants are treated that produce fruits or vegetables. In some embodiments, crop plants that produce vegetables are treated.

Among embodiments involving crop plants that produce vegetables, suitable plants include, for example, plants that produce cabbages, artichokes, asparagus, lettuce, spinach, cassava leaves, tomatoes, cauliflower, pumpkins, cucumbers and gherkins, eggplants, chilies and peppers, green onions, dry onions, garlic, leek, other alliaceous vegetables, green beans, green peas, green broad beans, string beans, carrots, okra, green corn, mushrooms, watermelons, cantaloupe melons, other melons, bamboo shoots, beets, chards, capers, cardoons, celery, chervil, cress, fennel, horseradish, marjoram, oyster plant, parsley, parsnips, radish, rhubarb, rutabaga, savory, scorzonera, sorrel, watercress, and other vegetables.

Some embodiments involve treatment of solanaceous plants or cucurbit plants. Solanaceous plants include, for example, Lycopersicon esculentum plants (including, for example, tomato plants); capsicum plants (including, for example, bell pepper, paprika, and chile pepper plants); and Solanum melongena plants (including, for example, eggplant, aubergine, or brinjal plants). Cucurbit plants include, for example, Citrullus lanatus (watermelon) plants, Cucumis sativus (cucumber) plants, Cucumis melo (all types of melon) plants, Cucumis anguria (bur gherkin) plants, Cucurbita (five species of squash & pumpkin) plants, Cucurbita pepo (summer squashes, pumpkin, scallops, straightnecks, zucchini, yellow-flowered gourd) plants, Cucurbita maxima (hubbard) plants, Cucurbita mixta (winter squash) plants, and Cucurbita moschata (butternut squash, banana squashes, and acorn squash) plants.

Some embodiments involve treatment of tomato plants, bell pepper plants, watermelon plants, cantaloupe plants, or musk melon plants.

Among embodiments involving treatment of tomato plants, suitable tomato plants include, for example, processing tomato plants and fresh-market tomato plants. Tomato plants are treated at least one time, with at least one treatment taking place at any time during any reproductive stage. In some embodiments, tomato plants are treated at one or more of the following times: one or more times during the period from initiation of the first bloom period to seven days after the initiation of the first bloom period; and one or more times during the period from 28 days before anticipated harvest until harvest. In some embodiments, tomato plants are treated at one or more of the following times: at the initiation of the first bloom period; seven days after the initiation of the first bloom period, 28 days before anticipated harvest, 21 days before anticipated harvest, 14 days before anticipated harvest, and any combination thereof.

Among embodiments involving treatment of tomato plants, suitable treatment rates include, for example, 5 g/ha or more; or 10 g/ha or more; or 20 g/ha or more. Independently, among embodiments involving treatment of tomato plants, suitable treatment rates include, for example, 100 g/ha or less; or 60 g/ha or less; or 30 g/ha or less.

Among embodiments involving treatment of bell pepper plants, the bell pepper plants are treated at least one time, with at least one treatment taking place at any time during any reproductive stage. In some embodiments, bell pepper plants are treated at the initiation of the first bloom period.

Among embodiments involving treatment of bell pepper plants, suitable treatment rates include, for example, 5 g/ha or more; or 10 g/ha or more; or 20 g/ha or more. Independently, among embodiments involving treatment of bell pepper plants, suitable treatment rates include, for example, 100 g/ha or less; or 60 g/ha or less; or 30 g/ha or less.

Among embodiments involving treatment of watermelon plants, the watermelon plants are treated at least one time, with at least one treatment taking place at any time during any reproductive stage. The timing of treatments of watermelon plants can usefully be described as “DAF”; i.e., days after flowering, which means the number of days after the beginning of flowering. In some embodiments, watermelon plants are treated one or more times at 1 to 14 DAF. In some embodiments, watermelon plants are treated at any one of or at any combination of the following timings: 1 DAF, 7 DAF, and 14 DAF.

Among embodiments involving treatment of watermelon plants, suitable treatment rates include, for example, 1 g/ha or more; or 2 g/ha or more; or 5 g/ha or more. Independently, among embodiments involving treatment of watermelon plants, suitable treatment rates include, for example, 100 g/ha or less; or 60 g/ha or less; or 30 g/ha or less.

Among embodiments involving treatment of cantaloupe plants, the cantaloupe plants are treated at least one time, with at least one treatment taking place at any time during any reproductive stage. In some embodiments, cantaloupe plants are treated one or more times in the period from bud initiation to 10 days after blossom opening. In some embodiments, cantaloupe plants are treated after bud initiation but before blossom opening. In some embodiments, cantaloupe plants are treated 10 days after blossom opening.

Among embodiments involving treatment of cantaloupe plants, suitable treatment rates include, for example, 5 g/ha or more; or 10 g/ha or more; or 20 g/ha or more. Independently, among embodiments involving treatment of cantaloupe plants, suitable treatment rates include, for example, 100 g/ha or less; or 60 g/ha or less; or 30 g/ha or less.

Among embodiments involving treatment of melon plants other than cantaloupe plants, the contemplated treatment timing and treatment rates are the same as those described herein above for cantaloupe plants.

Among embodiments involving crop plants that produce fruits, suitable plants include, for example, plants that produce bananas and plantains; citrus fruits; pome fruits; stone fruits; berries; grapes; tropical fruits; miscellaneous fruits; and other fruits. Citrus fruits include, for example, orange, tangerine, mandarin, clementine, satsumas, lemon, lime, grapefruit, pomellow, bergamot, citron, chinotto, kumquat, and other citrus fruits. Pome fruits include, for example, apple, pear, quince, and other pome fruits. Stone fruits include, for example, apricot, cherry, peach, nectarine, plum, and other stone fruits. Berries include, for example, strawberry, raspberry, gooseberry, currant, blueberry, cranberry, blackberry, loganberry, mulberry, myrtle berry, huckleberry, dangleberry, and other berries. Tropical fruits include, for example, fig, persimmon, kiwi, mango, avocado, pineapple, date, cashew apple, papaya, breadfruit, carambola, chrimoya, durian, feijoa, guava, mombin, jackfruit, longan, mammee, mangosteen, naranjillo, passion fruit, rambutan, sapote, sapodilla, star apple, and other tropical fruits. Miscellaneous fruits include, for example, azarole, babaco, elderberry, jujube, litchi, loquat, medlar, pawpaw, pomegranate, prickly pear, rose hips, rowanberry, service-apple, tamarind, and tree-strawberry.

In some embodiments of the present invention, a group of plants is treated simultaneously or sequentially. One characteristic of such a group of plants is the crop yield, which is defined as the amount (herein called “crop amount”) of useful plant parts collected from a defined group of plants. In one useful definition of the crop yield, the defined group of plants is the group that occupies a certain area of ground (this definition is often used when plants are growing in a contiguous group in a field). In another useful definition of the crop yield, the defined group of plants is a specific number of individually identified plants (this definition may be used for any group of plants, including, for example, plants in fields, in pots, in greenhouses, or any combination thereof).

The crop amount may defined in a variety of ways. In the practice of the present invention, the crop amount may be measured, for example, by any of the following methods: weight, volume, number of harvested plant parts, or biomass. Also contemplated are methods in which the crop amount is measured as the amount in the crop of a specific constituent (such as, for example, solids, sugar, starch, or protein). Further contemplated are methods in which the crop amount is measured as the amount of a certain characteristic (such as, for example, redness, which is sometimes used to measure the amount of a crop of tomatoes). Additionally contemplated are methods in which the crop amount is measured as the amount of a specific portion of the harvested plant part.

In some embodiments, the crop yield is defined as the crop amount per unit of area of land. That is, the land area from which the crop was harvested is measured, and the crop amount is divided by the land area to calculate the crop yield. For example, a crop amount measured as the weight of harvested plant parts would lead to a crop yield that is reported as a weight per area (for example, kilograms per hectare).

It is contemplated that, in some embodiments, the harvested plant parts that contribute to the crop amount are those plant parts that meet the minimum quality criteria that are appropriate for that type of plant part. That is, when plant parts are harvested from certain plants, the crop amount is, for example, the weight of the plant parts of acceptable quality that are harvested from those plants. Acceptable quality may be determined by any of the common criteria used by persons who harvest or handle the plant part of interest. Such criteria of acceptable quality of a plant part may be, for example, one or more of size, weight, firmness, resistance to bruising, flavor, sugar/starch balance, color, beauty, edibility, cosmetic appeal, overall appearance, suitability for sale, other quality criteria, or any combination thereof. Also contemplated as a criterion of quality, either alone or in combination with any of the foregoing criteria, is the time over which the plant part maintains its quality (as judged by any of the forgoing criteria).

A few illustrative (but not limiting) examples of crop amount are, for example, total weight of crop harvested; total number of plant parts harvested; weight (or number) of harvested plant parts that each meet or exceed some minimum weight for that type of plant part; or weight (or number) of harvested plant parts that each meet or exceed some minimum quality criterion (e.g., color or flavor or texture or other criterion or combination of criteria) for that type of plant part; weight (or number) of harvested plant parts that are edible; or weight (or number) of harvested plant parts that are able to be sold. In each case, as defined herein above, the crop yield is the crop amount per unit area of land on which the crop was grown.

In some embodiments of the present invention, treatment of a group of plants with the methods of the present invention will increase the crop yield of that group of plants, compared to the crop yield that would have been obtained from that group of plants if it had not been treated with the methods of the present invention. The increase in crop yield may be obtained in any of a wide variety of ways. For example, one way an increase in crop yield may be obtained is that each plant may produce a greater number of useful plant parts. As another example, one way an increase in crop yield may be obtained is that each useful plant part may have higher weight. As a third example, crop yield may increase when a larger number of potentially useful plant parts meets the minimum criteria for acceptable quality. Other ways of increasing the crop yield may also result from the practice of the present invention. Also contemplated are increases in crop yield that happen by any combination of ways.

Another contemplated benefit of practicing some embodiments of the present invention is that the general quality of the crop may be improved. That is, a crop produced by methods of the present invention may have a general or average level of quality higher than comparable crops produced without the methods of the present invention, as judged by the quality criteria appropriate for that crop. In some cases, such higher-quality crops may command higher prices when sold.

### EXAMPLES

In the Examples below, the following materials were used:
Powder 1=powder containing 3.8% 1-MCP by weight, available as AFXRD-038 from Rohm and Haas Co.
Powder 2=powder containing 2.0% 1-MCP by weight, available as AFXRD-020 from Rohm and Haas Co.
Adjuvant 1=Dyne-Amic™ spray oil, available from Helena Chemical

In the following examples, samples labeled “UTC” are untreated controls and are comparative examples. The remaining examples represent the present invention.

In the following examples, these procedures were used:

Spray tank was filled with approximately two-thirds of the total volume of water required. The amount of Powder 1 or Powder 2 was weighed according to the intended treatment rate and total volume of spray being prepared. The appropriate amount of was calculated to give 0.38% v/v of total spray volume. Adjuvant 1 was added to the spray tank, which was agitated until the mixture turned milky white. Powder 1 or Powder 2 was added to the spray container, which was then gently (not vigorously) agitated. The remaining water was added, making sure all of the powder was wet and washed off of the sides of the tank (if any had deposited there). The spray tank was then swirled or stirred for 2 to 5 minutes to ensure good mixing. Between 5 and 60 minutes thereafter, plants were sprayed with the mixture.

Flat fan nozzles were used, producing droplet size of 100 to 500 micrometers. Spray rate of mixture was 187 to 373 liter per hectare (20 to 40 gallons per acre). Carbon dioxide-powered backpack sprayer was used. Spraying was performed before 10:00 am.

In the following Examples, these abbreviations are used: ha for hectare, mT for metric ton, AI for 1-MCP, and wt for weight.

### Example 1

### Processing Tomatoes, Variety AB2

Tomato variety AB2 was grown in Gainesville, Fla. Treatment was conducted by spraying as described above, with concentration of spray liquid adjusted to give 25 g/ha (9.4 oz/acre) of 1-MCP. Treatment was performed at the following timings:

bloom1=initiation of the first bloom period

bloom2=7 days after initiation of the first bloom period

day28=28 days before anticipated harvest

day21=21 days before anticipated harvest

day14=14 days before anticipated harvest

Results were as follows:
Mass is fruit yield, reported as mT/ha (tons/acre)
°Brix is soluble solids (also called total soluble solids or soluble solids content) and is a measure of quality in tomatoes. °Brix yield is reported as solids weight per unit land area, i.e., mT/ha (tons/acre)
Delay is Harvest Delay, reported as % Mature Green
Number is fruit yield, reported as thousands of fruit per hectare (thousands per acre)

Trial 1

| Treatment Timing | Mass | °Brix | Delay |
|---|---|---|---|
| bloom1 | 243 (44) | 12.1 (2.18) | 10 |
| bloom1 and bloom2 | 227 (41) | 12.0 (2.17) | 11 |
| day 28 | 221 (40) | 11.6 (2.10) | 9 |
| UTC | 199 (36) | 10.5 (1.89) | 8 |

Trial 2

| Treatment | Mass | °Brix | Delay |
|---|---|---|---|
| bloom1 | 194 (35) | 11.0 (1.99) | 4 |
| bloom1 and bloom2 | 205 (37) | 11.5 (2.08) | 3 |
| day 28 | 183 (33) | 10.9 (1.97) | 4 |
| UTC | 177 (32) | 9.4 (1.70) | 5 |

Trial 3

| Treatment | Mass | °Brix | Delay |
|---|---|---|---|
| bloom1 and bloom2 | 111 (20) | 6.4 (1.15) | 13 |
| day 28 | 116 (21) | 6.3 (1.14) | 17 |
| UTC | 105 (19) | 5.8 (1.04) | 15 |

Trial 4

| Treatment | Mass | °Brix | Delay |
|---|---|---|---|
| bloom1 and bloom2 | 304 (55) | 14.9 (2.7) | 5 |
| UTC | 288 (52) | 14.4 (2.6) | 4 |

### Treated tomatoes showed improvement in Mass and °Brix over the UTC tomatoes.

### Example 2

### Processing Tomatoes, Variety 410

Tomato variety 410 was grown and treated as in Example 1. Results were as follows:

Trial 5

| Treatment | Mass | Number |
|---|---|---|
| bloom1 | 354 (64) | 2245 (909) |
| bloom2 | 376 (68) | 2406 (974) |
| UTC | 327 (59) | 2062 (835) |

### Treated tomatoes showed improvement in Mass and Number over UTC tomatoes.

### Example 3

### Fresh Market Tomatoes, Variety FL 47

Tomatoes of variety FL 47 were grown in Florida and were treated as described above. Yield is reported as mT/hectare (Cwt/acre, i.e., number of hundred-pound groups per acre) Results were as follows:

Trial 6

| Treatment | Yield |
|---|---|
| bloom1 | 27.0 (241) |
| bloom2 | 21.5 (192) |
| bloom1 and bloom2 | 23.3 (208) |
| UTC | 19.4 (173) |

Trial 7

| Treatment | Yield |
|---|---|
| bloom1 | 18.3 (163) |
| bloom2 | 18.6 (166) |
| bloom1 and bloom2 | 17.2 (154) |
| UTC | 15.8 (141) |

Trial 8

| Treatment | Yield |
|---|---|
| day 21 | 24.2 (216) |
| day 14 | 20.4 (182) |
| day 21 and day 14 | 22.3 (199) |
| UTC | 19.4 173) |

### Treated tomatoes showed improved yield over UTC tomatoes

### Example 4

### Bell Peppers

Bell Pepper of Lady Bell variety was grown in Fostoria, Ohio, on a small plot, and treated as in the Examples above, with one treatment at the initiation of the first bloom period. Treatment rates are reported as g/ha (oz/acre) Results are reported as Total Fruit (total number of Bell Peppers grown on the entire plot), Fruits per Plant (average over the plot), and Total Plants (total number of plants grown on the entire plot. “NS” means that the liquid composition had no surfactant. Results were as follows:

| Treatment Rate | Total Fruit | Fruits per Plant | Total Plants |
|---|---|---|---|
| UTC | 176 | 6.1 | 16 |
| 5 (1.9) | 292 | 10.1 | 23 |
| 25 (9.4) | 243 | 8.4 | 22 |
| 25 (9.4)NS | 231 | 8 | 22 |

### Treated bell pepper plants showed improvements over the UTC bell pepper plants.

### Example 5

### Watermelon

Watermelon (variety triploid cv. SS 7187) plants were treated as in Example 1 above. Treatment rates are reported in grams 1-MCP per hectare. Timing is reported as DAF (days after flowering). A marketable melon is a harvested melon with mass of 4.54 kg or greater. A cull is a harvested melon with mass less than 4.54 kg or an unharvested melon that had diameter greater than 5 cm. The following results are reported:
Num25=number of fruit of diameter greater than 5 cm per plant,
   assessed before harvest, at 25 DAF, also known as “fruit set”
NumTot=Harvested and Unharvested Fruits, 42-56 Days, with diameter greater than 5 cm
NumMark=number of marketable melons per plant
NumCull=number of culls per plant
Size=average size of fruit, in kg
Yield=mass of marketable melons, in metric tons per hectare
   Results were as follows:

TABLE 5.1

| Treatment Rate | Timing | Num25 | NumTot | Yield |
|---|---|---|---|---|
| UTC | — | 1.0 | 1.65 | 40.4 |
| 10 | 1 | 1.8 | 2.35 | 46.3 |
| 10 | 7 | 1.55 | 1.8 | 39.1 |

### Statistical analysis of the data that is summarized in table 5.1 showed that treatment at 1 DAF gave significant increase in both number and yield of watermelons over UTC.

TABLE 5.2

| Treatment | | | | | | |
|---|---|---|---|---|---|---|
| Rate | Timing | Num25 | NumMark | NumCulls | Yield | Size |
| UTC | — | 1.25 | 1.09 | 0.78 | 44.4 | 7.46 |
| 5 | 7 | 1.25 | 1.24 | 0.64 | 46.2 | 6.83 |
| 5 | 14 | 1.83 | 1.44 | 0.58 | 58.1 | 7.44 |
| 5 | 7 and 14 | 1.58 | 1.40 | 0.71 | 55.8 | 7.26 |
| 10 | 7 | 1.17 | 1.47 | 0.71 | 60.6 | 7.56 |
| 10 | 14 | 1.42 | 1.33 | 0.64 | 51.9 | 7.09 |
| 10 | 7 and 14 | 1.67 | 1.33 | 0.78 | 51.4 | 7.10 |
| 25 | 7 | 1.58 | 1.49 | 0.58 | 57.0 | 7.08 |
| 25 | 14 | 1.75 | 1.42 | 0.58 | 57.1 | 7.41 |
| 25 | 7 and 14 | 1.92 | 1.29 | 0.60 | 50.3 | 7.15 |

Statistical analysis of the data that is summarized in table 5.2 showed the following. Treatment at 25 g/ha resulted in significant increase in fruit set over the UTC. Treated plants showed significant increase number of marketable fruit over UTC. Treated plants showed significant increase in yield over UTC. Differences in fruit size between treated plants and UTC were not significant.

### Example 6

### Cantaloupe

Cantaloupe plants were treated as in Example 1. Timing of treatment was “Before” (before blossom opening) or “Blossom10” (10 days after blossom opening). The average first flower set (“Set”) was measured. Results were as follows:

| Treatment | Set |
|---|---|
| UTC | 0.137 |
| Before | 0.161 |
| Blossom10 | 0.0247 |

Treatment before blossom opening gave improved set over UTC.

We claim:

1. A method of treating horticultural crop plants comprising the step of contacting said plants one or more times with a liquid composition, wherein said liquid composition comprises one or more cyclopropenes, and wherein said contacting is performed during a reproductive stage of said plants.

2. The method of claim 1, wherein said contacting is performed at a rate of 1 to 300 g of said cyclopropene per hectare.

3. The method of claim 1, wherein said plants are selected from the group consisting of solanaceous plants and cucurbits.

4. The method of claim 1, wherein said plants are selected from the group consisting of watermelon plants, cantaloupe plants, bell pepper plants, and tomato plants.

5. The method of claim 1, wherein said plants are tomato plants and wherein one or more of said contacting steps is performed at a time selected from the group consisting of
(a) one or more times during the period from initiation of the first bloom period to seven days after initiation of the first bloom period,
(b) one or more times during the period from 28 days before anticipated harvest until harvest, and
(c) any combination thereof.

6. The method of claim 1, wherein said plants are bell pepper plants and wherein one or more of said contacting steps is performed at the initiation of the first bloom period.

7. The method of claim 1, wherein said plants are watermelon plants and wherein one or more of said contacting steps is performed at a time 1 to 14 days after flowering.

8. The method of claim 1, wherein said plants are cantaloupe plants and wherein one or more of said contacting steps is performed in the period from bud initiation to 10 days after blossom opening.
